(19) United States
(12) Patent Application Publication
(10) Pub. No.: US 2006/0238857 A1
(43) Pub. Date: Oct. 26, 2006

(54) Surgical Microscope

(76) Inventor: Ulrich Sander, Rebstein (CH)

Correspondence Address: HODGSON RUSS LLP, ONE M & T PLAZA, SUITE 2000, BUFFALO, NY, 14203-2391, US

(21) Appl. No.: 11/279,407

(22) Filed: Apr. 12, 2006

(30) Foreign Application Priority Data
Apr. 21, 2005 (DE) 10 2005 018 431.6

(51) Int. Cl. G02B 21/00

(52) U.S. Cl. 359/368

(57) ABSTRACT

A surgical microscope system comprises a stand (1) with a carrier arm (3, 4), an optical unit having a microscope body (2), an objective (13), and at least one eyepiece tube (10), and at least one input unit (5) having a display and a touch-based operating panel, the touch-based operating panel (7) being antimicrobial, e.g. as a result of the addition of silver, copper, or other chemical substances having antimicrobial properties.

### CROSS REFERENCE TO RELATED APPLICATIONS

This application claims priority of the German patent application 10 2005 018 431.6 filed Apr. 21, 2005 which is incorporated by reference herein.

### FIELD OF THE INVENTION

The invention relates to surgical microscope systems, in particular to a surgical microscope system including an antimicrobial touch-based operating panel in an input unit thereof.

### BACKGROUND OF THE INVENTION

A variety of input units are known in the existing art for operation of a microscope.

For surgical microscopes, which require a very wide range of inputs for operation, complex input units in the form of operating consoles having switch knobs and multifunction switches, and optionally having display units, are necessary. Such input units have the disadvantage that they are located in the nonsterile region, and must additionally be equipped with a display that, for example, also indicates the influence being exerted on a specific rotary controller

It is furthermore known to provide as an input unit a foot pedal or even a mouth switch, with which the surgeon controls various functions, for example modifying the magnification of the zoom system during the procedure.

In the context of the present patent application, the microscope body having the objective and the eyepiece tube with the eyepieces is referred to as an “optical unit.” The optical unit is delimited from the stand by a microscope carrier arm and optionally by an X-Y coupling. An X-Y coupling is a displacement carriage for the horizontally oriented X and Y axes, which moves the entire microscope body and with which modern surgical microscopes are usually equipped. These aforesaid components are carried by a floor stand or ceiling mount. Further components, for example input units, monitors, PCs, and operating keypads, can be mounted on the stand on further support arms constituting a counterweight to the optical unit. A necessary consequence of this type of installation is that because of their distance, such units are difficult for the surgeon to see and operate.

Carl Zeiss AG, Oberkochen, Germany markets a surgical microscope under the designation OPMI® Vario/NC33 System, in which a touch screen (touch-sensitive display screen) is arranged on the stand (see, for example, under www.zeiss.de/C12567BB004D29C6/allBySubject; OPMI Vario/NC33 system noticeably different).

This is intended to display to the surgeon the main settings of the system. A disadvantage, however, is that the surgeon must turn away from the object or the surgical microscope if he or she wishes to view or operate this touch screen. It is moreover located in the nonsterile region of the surgical microscope, which as a rule is covered with a sterile drape during the procedure. This touch screen is therefore more suitable for operation by auxiliary personnel, for example, by a surgical nurse, but not for operation by the surgeon him- or herself.

### SUMMARY OF THE INVENTION

It is the object of the present invention to improve the operation of a microscope, in particular of a surgical microscope. The intention in particular is to improve the visibility and accessibility of the input units, and the input is intended to meet increased demands in terms of asepsis, decreased cleaning requirement, and improved hospital hygiene in general.

This object is achieved by a surgical microscope system according to the present invention that comprises a stand having at least one carrier arm, and having an optical unit with a microscope body, at least one eyepiece tube, and at least one input unit. This input unit in turn comprises an antimicrobial touch-based operating panel.

The term “touch-based operating panel” is understood as a touch-sensitive surface, reactions being initiated by touching. There are various systems in the existing art. Touch pads, also referred to as touch panels, and touch screens, also referred to as sensor screens, are known, for example. Touching can be performed with a finger or with an instrument, depending on the system. The size and nature of the touch-based operating panel are based on the mounting location and on the nature and variety of the microscope functions.

The antimicrobial touch-based operating panel can be mounted at various points on the overall surgical microscope system. Preferred locations are, for example, the optical unit, in particular the exterior of the microscope body, or the eyepiece tube, the microscope carrier arm, and the X-Y coupling of the microscope carrier arm. The touch-based operating panel is mounted in such a way that it is easily reachable by the surgeon for operating purposes, and so that it is easily visible with no need to divert his or her attention from the object.

According to the present invention, at least one antimicrobial touch-based operating panel is provided. Preferably, however, several (in particular, two) antimicrobial touch-based operating panels can be provided. This is advantageous because it is usual in surgical microscopes for two pairs of eyepieces to be provided, so that two surgeons can work simultaneously on the object and can perform or assist with the procedure. These two surgeons, or a surgeon and an assistant, sit or stand at right angles to or opposite one another when operating the surgical microscope. For this reason, two different touch-based operating panels, easily visible to and operable by each person, are also desirable.

This is also advantageous if control of the microscope is also to be carried out by persons other than the surgeon, or if different command and control groups are provided on the various antimicrobial touch-based operating panels.

The touch-based operating panel used as an input unit is finished in antimicrobial fashion. This can be achieved, for example, by way of a corresponding antimicrobial coating. Examples of such coatings are metal-ion-containing, copper-containing, and/or silver-containing antimicrobial agents. Homotropic liquid silane crystals can also be used, or zeolites are used as carriers for time-delayed release of the antimicrobial agents.

The surgical microscope system according to the present invention offers the advantage that the surgeon has available to him or her a touch-based operating panel that can be operated in his or her immediate working region. He or she consequently need not, as in the existing art, turn away from the object, turn toward the stand, and attempt, through a drape that in some cases may even be distorted, to view data or to effect a change in the microscope's adjustment. The requirements in terms of asepsis are also met. In contrast to the known input units which comprise knobs and controllers, the touch-based operating panel not only is well-suited for asepsis because of its flat structure having few projections and gaps (it being difficult or impossible for microbes and contaminants to be deposited), but in addition, according to the present invention, it is already finished in antimicrobial fashion. A dual advantage is thereby provided, which would not have been achieved solely by displacing the touch screen from the stand, where it is known in the existing art, to the optical unit, or by replacing an “ordinary” touch screen with an antimicrobial touch-based operating panel.

The surgeon can thus act on the microscope's control system even during the surgical procedure. For that purpose, the input unit is in his or her vicinity, supplies unequivocal information, and is easy to operate. It is furthermore important that sterility during the procedure is protected, this being achieved by the antimicrobial finishing of the touch-based operating panel.

In addition, in order to display the data and/or functions selected with the aid of the antimicrobial touch-based operating panel, a display unit, e.g. a display, is provided at the objective end of the microscope, in particular in the immediate vicinity of the touch-based operating panel of the present invention. The antimicrobial touch-based operating panel can also be integrated into the display. OLEDs are preferably used to constrict the display. OLEDs are organic light-emitting diodes that are made up of self-luminous layers of plastic less than a thousandth of a millimeter thick. They are well known in the existing art. The reader is referred in this context to the Applicant's related application entitled “Optical System With Display”—Internal Reference 033997.00133—claiming priority of DE 10 2005 018 432.4 filed Apr. 21, 2005—filed on the same date as the present application, the teachings of which are combinable with this Application and vice versa.

Further embodiments and details of the invention are described in FIG. 2. The Claims, Figures, and Parts List are constituents of the disclosure.

### BRIEF DESCRIPTION OF THE DRAWINGS

The invention will be explained in more detail, in symbolic and exemplifying fashion, with reference to figures. The Figures are described in continuous and overlapping fashion. Identical reference characters denote identical components; reference characters having different indices indicate functionally identical or similar components. In the drawings:

FIG. 1 schematically depicts a surgical microscope system according to the existing art; and

FIG. 2 schematically depicts a portion of a surgical microscope system according to the present invention.

### DETAILED DESCRIPTION OF THE INVENTION

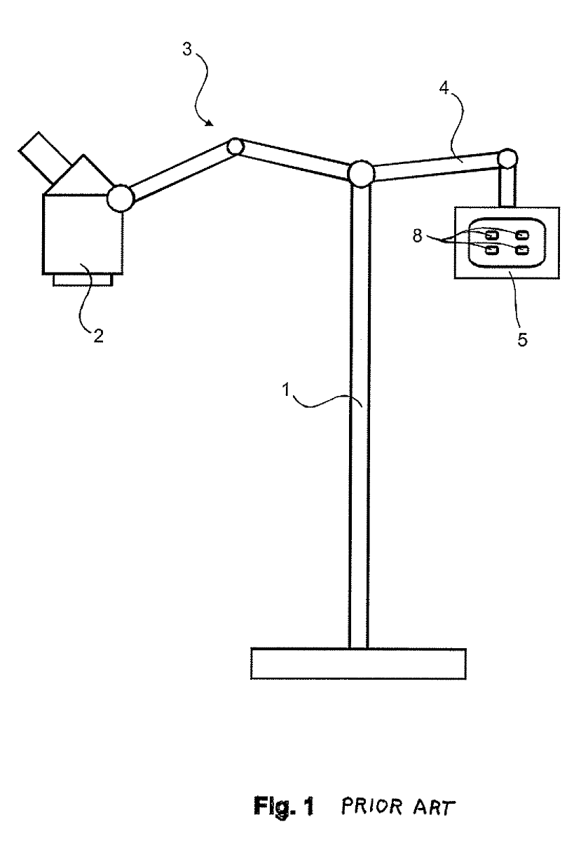

FIG. 1 depicts a conventional surgical microscope system according to the existing art. Two carrier arms 3 and 4 are supported on a stand 1. The one carrier arm 3 carries microscope body 2, and the other carrier arm 4 carries input unit 5. Input unit 5 comprises operating knobs and switches, of which four operating knobs 8 are shown for illustrative purposes.

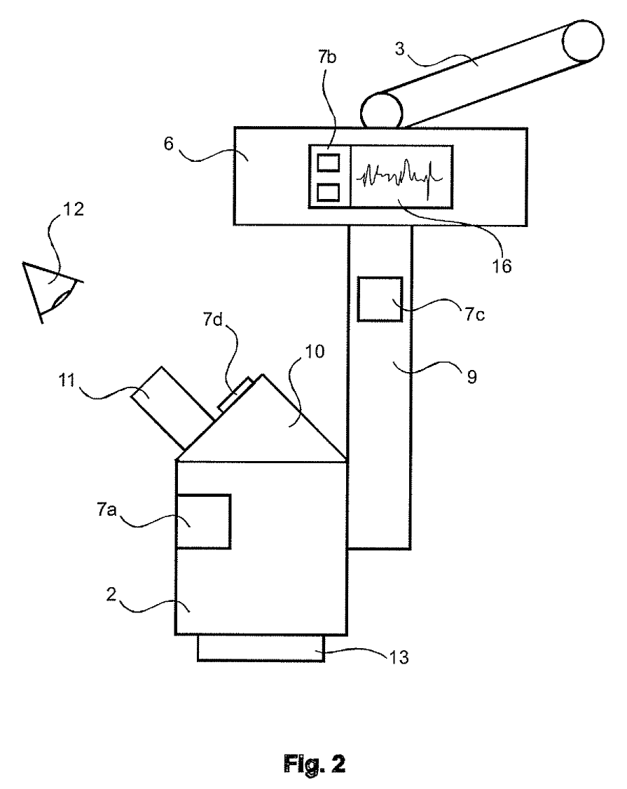

FIG. 2 shows only the a portion of a surgical microscope system, specifically X-Y coupling 6 and microscope body 2 which are secured pivotably on carrier arm 3. Microscope body 2 itself is carried by microscope carrier arm 9. The microscope comprises an objective 13 and an eyepiece tube 10 having eyepieces 11 (only one being visible) into which a symbolic viewer's eye 12 looks. Microscope body 2 with its constituents, in particular objective 13 and eyepiece tube 10, is referred to in the context of the present invention as an “optical unit.”

According to the present invention, at least one antimicrobial touch-based operating panel 7 is mounted on the overall stand arrangement as an input unit. Possible mounting locations that are suitable for this are 7a on microscope body 2, 7b on X-Y coupling 6, 7c on microscope carrier arm 9, or 7d on eyepiece tube 10. The touch-based operating panel 7 is finished in antimicrobial fashion. This can be achieved, for example, by way of a corresponding antimicrobial coating. Examples of such coatings are metal-ion-containing, copper-containing, and/or silver-containing antimicrobial agents. Homotropic liquid silane crystals can also be used, or zeolites are used as carriers for time-delayed release of the antimicrobial agents. Examples of antimicrobial touch screens have been disclosed in WO-A1-01/46900, WO-A1-00/43831, and EP-B1-0942351. Numerous possibilities for antimicrobial finishing are known in general from the existing art, and the invention is not limited to the aforementioned agents. The antimicrobial agents that are selected should not, however, diminish the resistive and/or capacitative touch effect.

A surgical microscope system according to the present invention can moreover be equipped with two touch-based operating panels, for example both on the exterior of microscope body 2 and, for example, on X-Y coupling 6 having an antimicrobial touch-based operating panel 7. Provision is made in this case for the two antimicrobial touch-based operating panels at respective mounting locations 7a, 7b to offer the same command capabilities, so that the surgeon can make his or her inputs—for example can have device data, CT data, X-ray images, or video sequences displayed, or can modify the microscope's settings—both on antimicrobial touch-based operating panel 7a on microscope body 2 and on antimicrobial touch-based operating panel 7b on X-Y coupling 6.

Consideration has also been given, however, to having the command capabilities of the two antimicrobial touch-based operating fields 7a and 7b be different. For example, antimicrobial touch-based operating panel 7a could permit only microscope-specific commands, i.e. those that the surgeon requires directly for the surgical procedure. Antimicrobial touch-based operating panel 7b, on the other hand, could permit only the input of general commands and inputs, i.e. commands that are relevant, for example, to an assistant.

Antimicrobial touch-based operating panel 7b is combined with a display unit 16, for example a screen or display, in particular an OLED display, thereby linking the input and display functions. The operator of the microscope, or other persons, can thus both input commands and also have those commands, or other data, displayed. As is evident from the depiction, display unit 16 is located in the immediate vicinity of antimicrobial touch-based operating panel 7, or they are combined with one another into one input/presentation unit.

A very wide variety of inputs and commands are possible with antimicrobial touch-based operating panel 7. The microscope can be controlled directly, e.g. in terms of zoom, magnification, light intensity, etc. The surgeon should also, if possible, be able to have data and additional information displayed. In particular, the possibility should also exist of switching in individual beam paths of the microscope, and overlaying data and images into the individual beam paths of the microscope. Provision is made in general, for example, for influencing the display of system data, in particular magnification, menu selection, color selection, brightness, etc. It should also be possible to select the display, in particular the controlled display, of data for the surgeon and/or data for auxiliary personnel.

### PARTS LIST

1 Stand
2 Microscope body
3 Carrier arm for a microscope body 2
4 Carrier arm for a touch sensor 5
5 Input unit
6 X-Y coupling
7 Antimicrobial touch-based operating panel
7a-7d Antimicrobial touch-based operating panels; panel mounting locations
8 Operating knob
9 Microscope carrier arm
10 Eyepiece tube
11 Eyepiece
12 Viewer's eye
13 Objective
16 Display unit

What is claimed is:

1. A surgical microscope system comprising:
a stand (1) including a carrier arm;
an optical unit mounted on the carrier arm, the optical unit including a microscope body (2), an objective (13), and at least one eyepiece tube (10); and
an input unit (5, 7) including a display and a touch-based operating panel, wherein the touch-based operating panel (7) is antimicrobial.

2. The surgical microscope system according to claim 1, wherein antimicrobial properties of the antimicrobial touch-based operating panel (7) result from one or more chemical substances applied thereto.

3. The surgical microscope system according to claim 2, wherein the one or more chemical substances are chosen from a group of chemical substances consisting of copper-containing antimicrobial agents, silver-containing antimicrobial agents, and homotropic liquid silane crystals.

4. The surgical microscope system according to claim 2, wherein the one or more chemical substances include nanometals.

5. The surgical microscope system according to claim 2, wherein the one or more chemical substances on the antimicrobial touch-based operating panel (7) are embedded in zeolite for time-delayed release.

6. The surgical microscope system according to claim 1, wherein the antimicrobial touch-based operating panel (7) is mounted on the optical unit.

7. The surgical microscope system according to claim 6, wherein the antimicrobial touch-based operating panel (7) is mounted on the microscope body.

8. The surgical microscope system according to claim 6, wherein the antimicrobial touch-based operating panel (7) is mounted on an eyepiece tube (10).

9. The surgical microscope system according to claim 1, wherein the antimicrobial touch-based operating panel (7) is mounted on the carrier arm.

10. The surgical microscope system according to claim 1, further comprising an X-Y coupling mounting the optical unit on the carrier arm, wherein the antimicrobial touch-based operating panel (7) is mounted on the X-Y coupling.

11. The surgical microscope system according to claim 1, wherein the input unit includes more than one antimicrobial touch-based operating panel (7).

12. The surgical microscope system according to claim 11, wherein the input unit includes exactly two antimicrobial touch-based operating panels.

13. The surgical microscope system according to claim 1, wherein the antimicrobial touch-based operating panel (7) is a touch screen or a touch pad.

14. The surgical microscope system according to claim 13, wherein the display is an organic light emitting diode (OLED) display.

15. The surgical microscope system according to claim 14, wherein the OLED display is combined with the touch screen.

16. The surgical microscope system according to claim 1, further comprising a computer connected to the input unit, wherein the computer provides signals for controlling zoom, focus, and video camera functions of the optical unit in reposne to user actuation of the antimicrobial touch-based operating panel (7).

17. In a surgical microscope system including a stand having a carrier arm, an optical unit mounted on the carrier arm having a microscope body and at least one eyepiece tube, and an input unit, the improvement comprising:
the input unit having an antimicrobial touch-based operating panel.

18. The improvement according to claim 17, wherein the antimicrobial touch-based operating panel (7) is used to control system functions including magnification, menu selection, color selection, and brightness.

19. The improvement according to claim 17, wherein the antimicrobial touch-based operating panel (7) is used to select the controlled display of data for the surgeon and data for auxiliary personnel.
